(19) United States
(12) Patent Application Publication
(10) Pub. No.: US 2014/0058856 A1
(43) Pub. Date: Feb. 27, 2014

(54) Point-of-Sale System

(71) Applicant: Burroughs, Inc., Plymouth, MI (US)

(72) Inventors: Robert A. Walters, Northville, MI (US); Joseph M. Gagnier, Birmingham, MI (US)

(73) Assignee: Burroughs, Inc., Plymouth, MI (US)

(21) Appl. No.: 13/972,763

(22) Filed: Aug. 21, 2013

Related U.S. Application Data
(60) Provisional application No. 61/692,050, filed on Aug. 22, 2012.

(51) Int. Cl. G06Q 20/20

(52) U.S. Cl. CPC G06Q 20/20
USPC 705/16

(57) ABSTRACT

One aspect of the disclosure provides a point-of-sale terminal system. The system includes a till, a bill manipulator, and a bill acceptor. The till has a plurality of slots, with each slot being configured to hold currency in the form of bills. The bill manipulator is coupled to the plurality of slots, and a bill acceptor is coupled to the bill manipulator. The bill manipulator moves individual bills from the till to the bill acceptor and the bill acceptor outputs bills to a currency storage unit. The system also includes a processing device configured to determine a number of bills in each of the plurality of slots, to determine a number N indicating a number of bills to remove from a slot of the plurality of slots based on the number of bills in the slot, and to command the bill manipulator to transfer N bills from the slot.

### CROSS REFERENCE TO RELATED APPLICATIONS

This U.S. patent application claims priority under 35 U.S.C. §119(e) to U.S. Provisional Application 61/692,050 filed on Aug. 22, 2012. The disclosures of these prior applications are considered part of the disclosure of this application and are hereby incorporated by reference in their entireties.

### TECHNICAL FIELD

This disclosure relates to a point-of-sale system, and in particular, a point-of-sale system configured to count the number of bills in a till and to transfer bills from a till to a secure location.

### BACKGROUND

Point-of-sale systems, e.g., cash registers, are essential to brick and mortar consumer businesses such as gas stations, restaurants, movie theatres, retail stores, and grocery stores. In operation, a point-of-sale system may store hundreds of dollars, making them enticing targets for criminals or inside jobs. For example, many “robberies” conveniently occur during the time the cashier is emptying the till and counting the cash at the end of a shift.

### SUMMARY

One aspect of the disclosure provides a point-of-sale terminal system. The system includes a till, a bill manipulator, and a bill acceptor. The till has a plurality of slots, with each slot being configured to hold currency in the form of bills. The bill manipulator is coupled to the plurality of slots, and a bill acceptor is coupled to the bill manipulator. The bill manipulator moves individual bills from the till to the bill acceptor and the bill acceptor outputs bills to a currency storage unit. The system also includes a processing device configured to determine a number of bills in each of the plurality of slots, to determine a number N indicating a number of bills to remove from a slot of the plurality of slots based on the number of bills in the slot, and to command the bill manipulator to transfer N bills from the slot.

Implementations of the disclosure may include one or more of the following features. In some implementations, the currency storage unit of the point-of-sale terminal system may be a safe that receives the bills from the bill acceptor. In some examples, the processing device may be further configured to facilitate a transaction, determine an amount of currency received during the transaction, and update an expected cash value of the till based on the amount of currency received during the transaction.

In some implementations, the point-of-sale terminal may further include a plurality of weight sensors. Each weight sensor is coupled to a respective slot of the plurality of slots and configured to output a weight of the respective slot. Additionally or alternatively, the processing device may determine the number of bills in each of the plurality of slots based on the weight of the slot.

In some examples, the processing device of the point-of-sale terminal may further be configured to command the bill manipulator to empty the bills in each of the plurality of tills into the bill acceptor, receive a value of each bill passed through the bill acceptor, and determine a final amount of currency in the till based on the respective values of the bills passed through the bill acceptor. The bill acceptor may be configured to verify the authenticity of a received bill and the value of the received bill.

Another aspect of the disclosure provides a point-of-sale system including a till having a slot, a bill manipulator, and a bill acceptor coupled to the bill manipulator. The bill manipulator moves individual bills from the slot to the bill acceptor and the bill acceptor outputs bills to a currency storage unit. The system also includes a processor configured to determine a number of bills in the slot, determine a number N indicating a number of bills to remove from the slot based on the number of bills in the slot, and command the bill manipulator to transfer N bills from the slot to the currency storage unit.

In some implementations, the currency storage unit of the system may be a safe that receives the bills from the bill acceptor. In some examples, the processing device may be further configured to facilitate a transaction, determine an amount of currency received during the transaction, and update an expected cash value of the till based on the amount of currency received during the transaction.

In some implementations, the point-of-sale terminal may further include a weight sensor coupled to the slot that outputs a weight of the slot. Additionally or alternatively, the processing device may determine the number of bills in the slot based on the weight of the slot.

In some examples, the processing device of the point-of-sale terminal may further be configured to command the bill manipulator to transfer all of the bills in the slot into the bill acceptor, receive a value of each bill passed through the bill acceptor, and determine a final amount of currency in the till based on the respective values of the bills passed through the bill acceptor. The bill acceptor may be configured to verify the authenticity of a received bill and the value of the received bill.

Yet another aspect of the disclosure provides a method of operating a point-of-sale system. The method includes determining, at a processing device, a number of bills in a slot of a till, and determining, at the processing device, whether the number of bills exceeds a threshold. When the number of bills exceeds the threshold, the method includes determining, at the processing device, a number N indicating a number of bills to remove from the slot based on the number of bills in the slot, and commanding, from the processing device, a bill manipulator to transfer N bills from the slot to a secure location. In some implementations, the secure location is a safe.

In some examples, the method of determining the number of bills in the slot may include receiving, at the processing device, a weight signal indicating the weight of the slot, determining, at the processing device, a weight of the bills in the slot based on the weight signal, and determining, at the processing device, the number of bills in the slot based on the weight of the bills. The method may include performing a determination as to whether the number of bills in the slot exceeds a threshold upon determining that an expected value of bills in the till exceeds a value threshold.

In some implementations, the number N is based on a difference between the number of bills in the slot and a reset number of bills. The reset number of bills indicates a number of bills to have in the slot after the bills are transferred to the secure location.

The method may further include transferring, by the bill manipulator, the number of bills from the slot to the secure location. The bill manipulator feeds the bills into a bill acceptor and the bill acceptor outputs the bills into the secure location.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1A is a schematic illustrating an example a point-of-sale system according to some implementations of the present disclosure.

FIG. 1B is a schematic illustrating example components of the point-of-sale system according to some implementations of the present disclosure.

FIGS. 2A-2F are schematics illustrating a bill manipulator according to some implementations of the present disclosure.

FIGS. 3A-3D are schematics illustrating a bill manipulator according to some implementations of the present disclosure.

FIG. 4 is a schematic illustrating example components of a computing system that controls the point-of-sale system.

FIG. 5 is a flow chart illustrating an example set of operations of a method for skimming a slot of a till.

FIG. 6 is a flow chart illustrating an example set of operations of a method for counting the bills in a till.

Like reference symbols in the various drawings indicate like elements.

### DETAILED DESCRIPTION

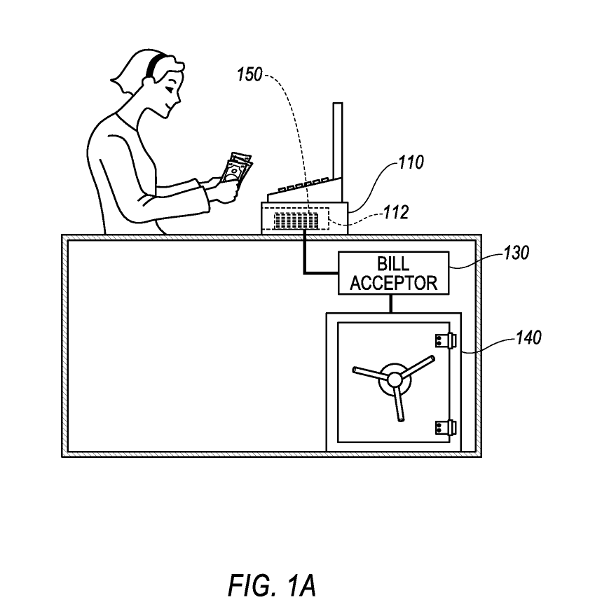

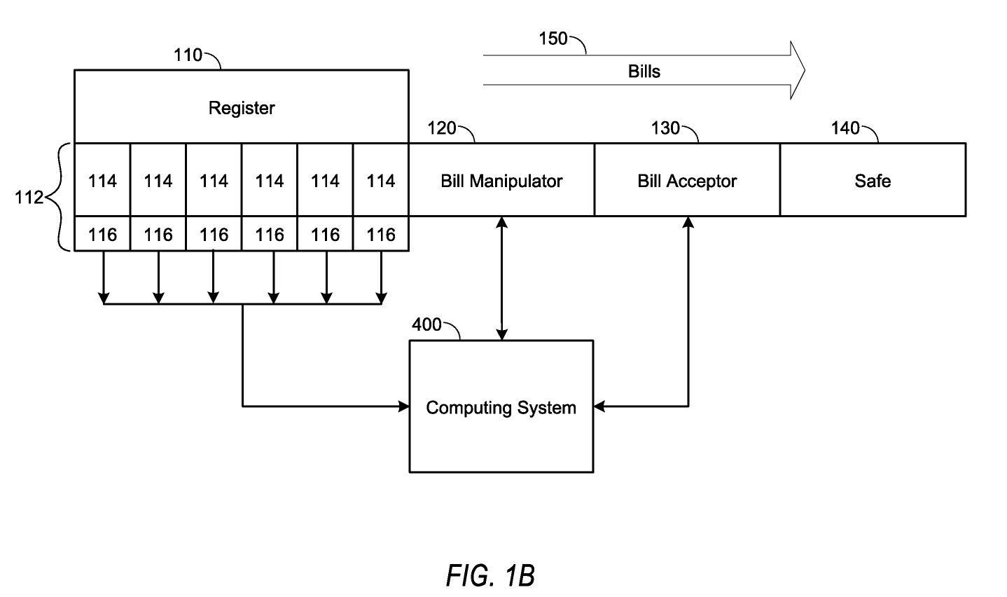

Referring now to FIGS. 1A and 1B, an example point-of-sale system 100 is depicted. The example point-of-sale system 100 includes a register 110, a bill manipulator 120, a bill acceptor 130, a safe 140, and a computing system 400. In the illustrated example, the register 110 includes a till 112 having a plurality of slots 114. A slot 114 can hold paper currency (also referred to as “cash” or “bills”). In some of these implementations, each slot 114 can have a weight sensor 116 coupled thereto. The point-of-sale system 100 is configured to monitor the amount of bills 150 in the register 110, determine amounts of bills 150 to transfer from the register 110 to the safe 140, and to transfer the bills 150 from the register 110 to the safe 140 by way of the bill manipulator 120 and the bill acceptor 130. The point-of-sale system 100 can also count the amount of bills 150 in the register 110 and deposit the counted bills 150 in the safe 140. Thus, the point-of-sale system 100 transfers bills 150 from an unsecure location (e.g., the register 110) to a secure location (e.g., the safe). It is noted that the point-of-sale system 100 may include additional components not shown in FIG. 1. For example, the point-of-sale system 100 may include a bill recycler that transfers bills 150 from the safe 140 to the till 120 and inserts the bills 150 into the appropriate slot 114 of the till 112. Additionally or alternatively, the till 112 can include drawers for coins.

In operation, a user (e.g., a cashier) receives currency in the form of bills 150 and/or coins. The user places the bills 150 in the till 112, and in particular, one or more of the slots 114.

For example, the till 112 may include slots 114 for one dollar, five dollar, ten dollar, twenty dollar, fifty dollar, and one hundred dollar bills. If the user receives a twenty dollar bill and three one dollar bills for a $22.50 transaction, the user can insert the twenty dollar bill in a slot 114 reserved for twenty dollar bills and the three one dollar bills in the slot 114 reserved for one dollar bills. The user or an automated mechanism can give the paying customer fifty cents in coins. It is noted that the foregoing is an example configuration of the slots 114 of a till 112 and other configurations of a till 112 are contemplated (e.g., a till 112 having slots 114 reserved for ones, fives, tens, and twenties only).

In some implementations, the cash value of the bills 150 in a particular slot 114 can be determined based on the weight of the particular slot 114 and the denomination of the bills 150 in the slot 114. In these implementations, weight sensors 116 can be coupled to or integrated into the slots 114, such that each weight sensor 116 corresponds to a respective slot 114. Further, the till 112 can be assembled such that each slot 114 is releasable from the rest of the till 112 so that the weight of the individual slot 114 can be determined by the corresponding weight sensor 116. The weight sensor 116 outputs the weight of the slot 114 to the computing system 400. The computing system 400 (described in greater detail below) can determine the amount of bills 150 in a slot 114 and/or the cash value of the slot 114 based on the outputted weight. Additionally or alternatively, the till 112 can include other components for determining the number of bills 150 in a slot 114 and/or a cash value of each slot 114. For example, the till 112 can include optical sensors in each of the slots that can be used to determine the amount of bills 150 in each slot 114.

In some countries, such as the United States, the weight or mass of a bill 150 is consistent regardless of its denomination (e.g., each denomination weighs one gram). Thus, in order for the computing system 400 to accurately determine the cash value of a particular slot 114, the slots 114 should be maintained in a predetermined manner (e.g., one dollar bills to the very left, followed by five dollar bills, ten dollar bills, twenty dollar bills, fifty dollar bills, and hundred dollar bills to the very right). In this way, when the weight of the bills 150 in a particular slot 14 is five grams, the computing system 400 can determine that the value of the slot 114 is five dollars (five one dollar bills) or one hundred dollars (five twenty dollar bills) based on the location of the slot 114 to which the weight sensor 116 output corresponds.

The bill manipulator 120 receives commands from the computing system 400 to remove one or more bills 150 from a particular slot 114 and moves the requested amount of bills 150 from the slot 114. The bill manipulator 120 can operate in any suitable manner.

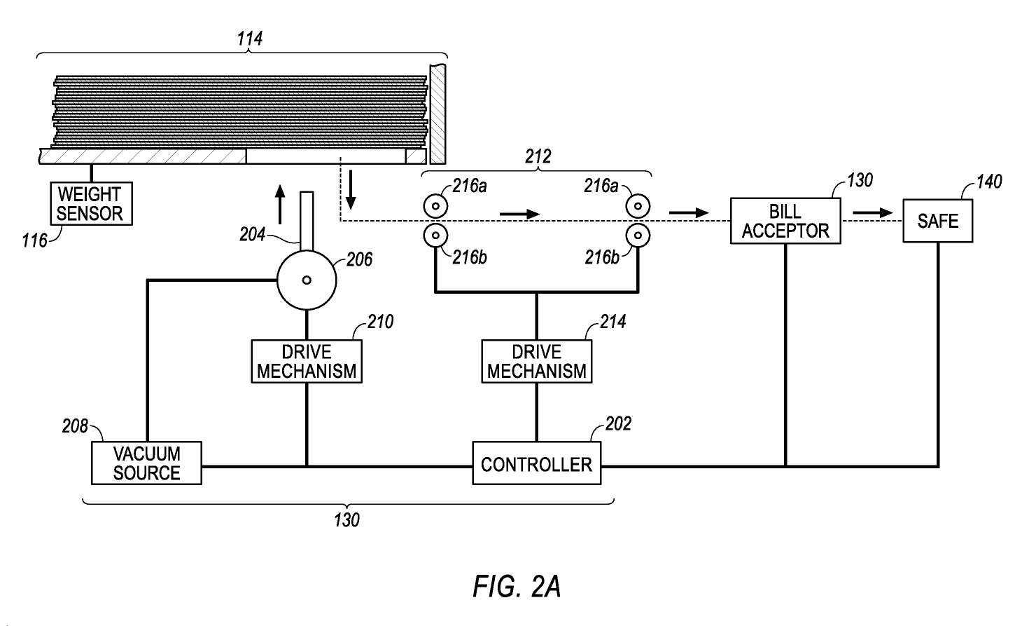

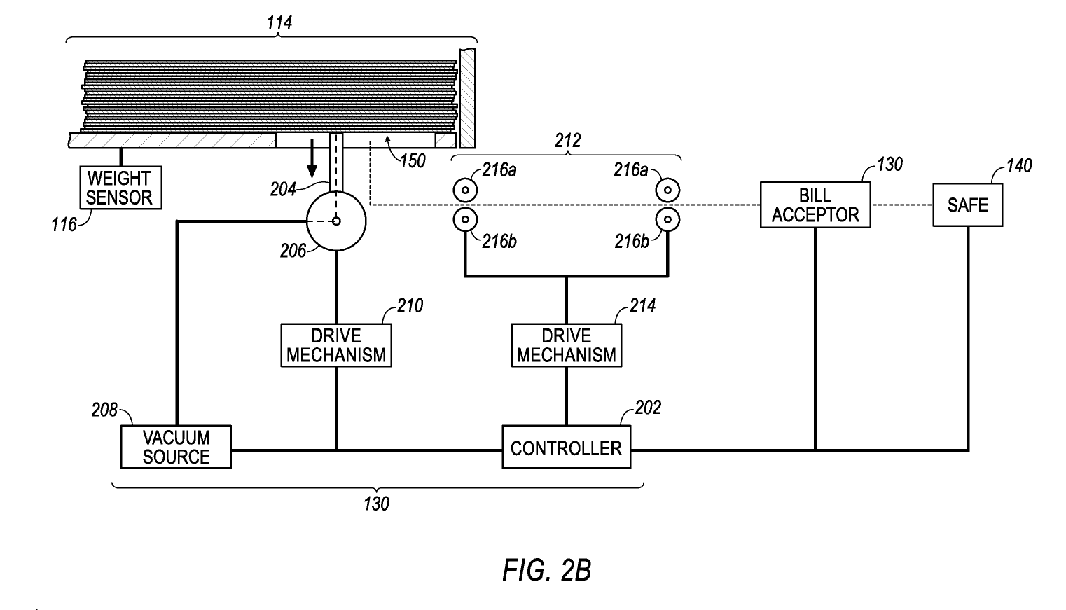

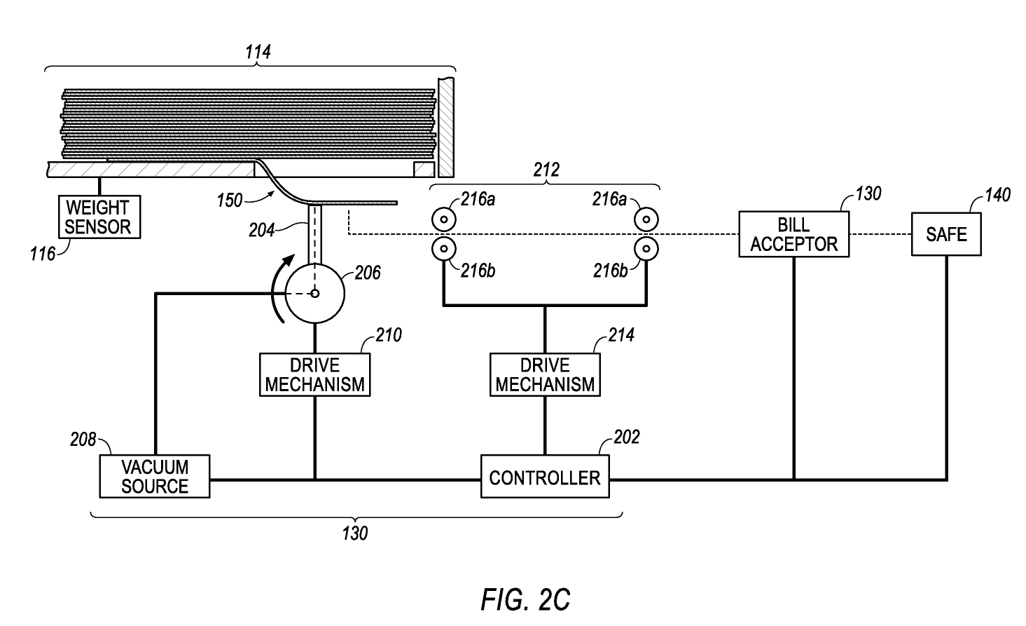

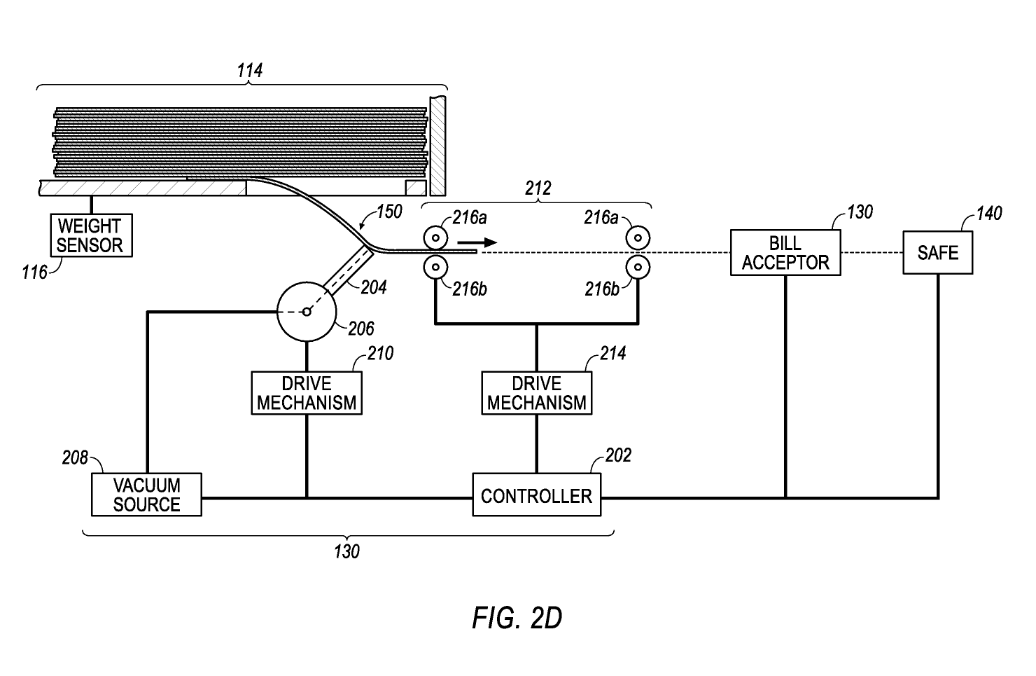

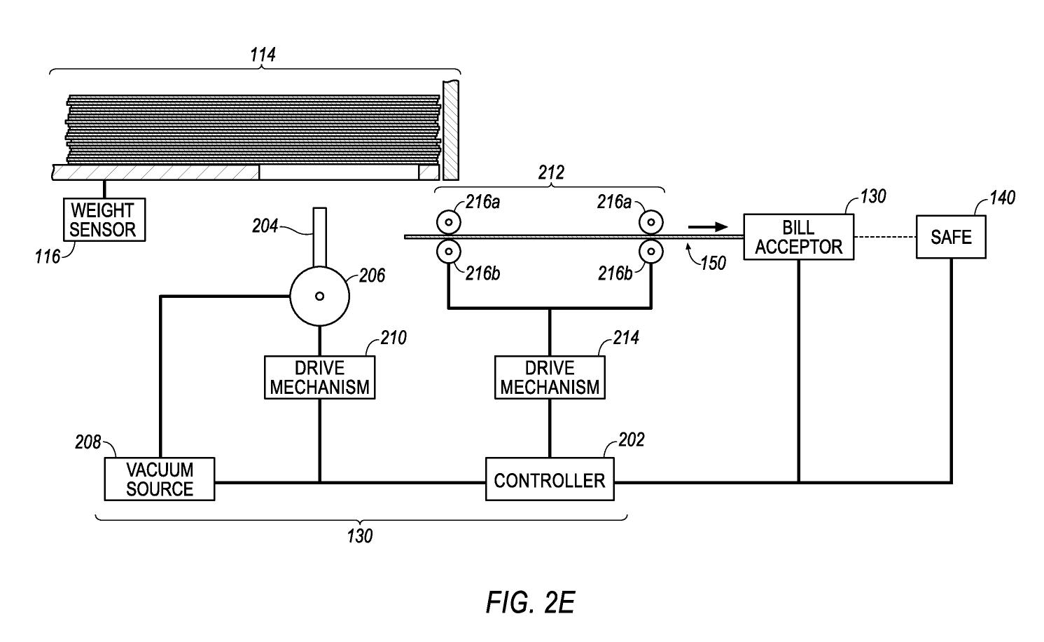

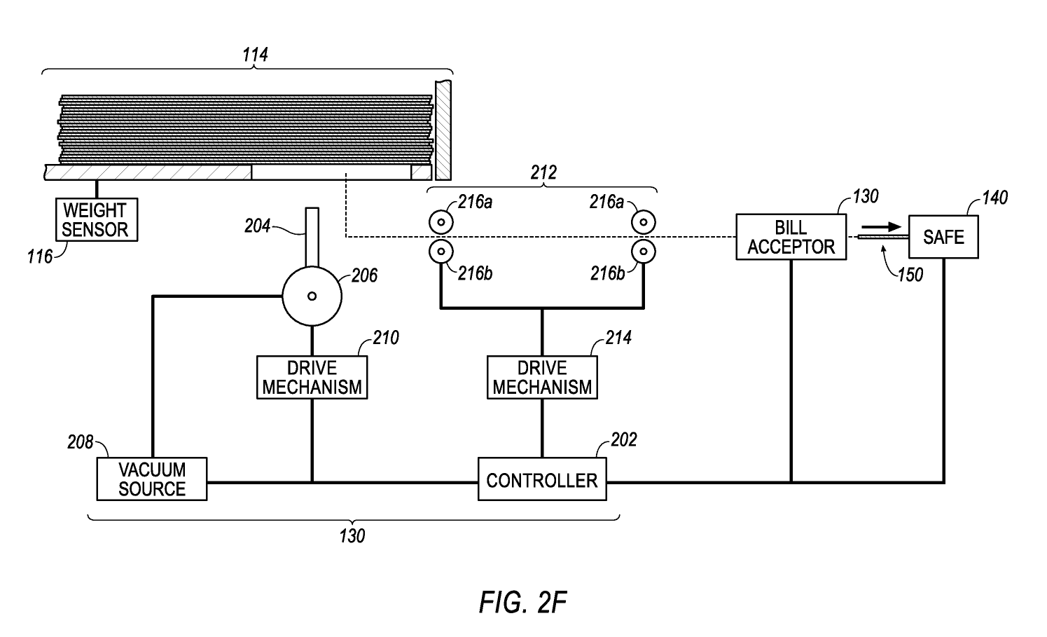

FIGS. 2A-2F illustrate a first example bill manipulator 200. In some implementations of the point-of-sale system 100, the first example bill manipulator 200 (or variations thereof) is the bill manipulator 120. In the first example, the bill manipulator 200 includes a controller 202, a vacuum tube 204, a vacuum wheel 206, a vacuum source 208, a vacuum drive mechanism 210, a wheeled guide 212, and a wheel guide drive mechanism 214.

In some embodiments, the controller 202 can be configured to receive commands from the computing system 400 to transfer a bill 150 from a defined slot 114. For example, the command may indicate a slot 114. In response to the command, the controller 202 controls the transfer of one bill from the slot 114 to the safe 140 by way of the bill acceptor 130.

Additionally or alternatively, the controller 202 can be configured to receive commands from the computing system 400 to transfer a defined number of bills 150 from a defined slot 114. In these implementations, the command can indicate a number of bills 150 to transfer, N, and a slot 114. In response to such a command, the controller 202 can control N transfers of bills 150 from the defined slot 114. According to some implementations of the bill manipulator 200, the controller 202 can be configured to provide an acknowledgment to the computing system 400 when the controller 202 completes a successful bill transfer.

The vacuum conduit (e.g., tube) 204 has a cavity extending therethrough such that the cavity extends from its distal end to a coupling point with the vacuum wheel 206. The vacuum wheel 206 also includes a cavity that at least extends from the coupling point with the vacuum tube 204 to a coupling point with the vacuum source 208. The vacuum source 208 creates a vacuum suction and couples to the vacuum wheel 206. By way of the vacuum wheel 206, when the vacuum source 208 creates a vacuum suction, the vacuum suction is realized at the tip of the vacuum tube 204. Drive mechanism 210 may be capable of effecting (1) linear movement 211 of vacuum wheel 206 and (2) rotational movement 213 of vacuum wheel 206.

The wheeled guide 212 includes two sets of wheels 216. Each set of wheels 216 includes at least two wheels 216 (i.e., a top wheel 216a and a bottom wheel 216b). When activated by the wheeled guide drive wheel mechanism 214, the top wheel 216a and the bottom wheel 216b rotate in opposite directions (e.g., the top wheel 216a can rotate in a counterclockwise manner and the bottom wheel 216b can rotate in a clockwise manner). In this way, the bill 150 is guided through the set of wheels 216 towards the bill acceptor 130.

In operation, the vacuum tube 204 and the vacuum wheel 206 may be located at a first (rest) position when the bill manipulator 200 is inactive (FIG. 2A). The controller 202 can receive a command to remove a bill 150 from the slot 114. In response to the command to remove the bill 150, the controller 202 commands the vacuum drive mechanism 210 to move linearly to a second position, such that the vacuum tube 204 is abutting or nearly abutting the bottommost bill 150. The controller 202 can also activate the vacuum source 208, which creates a vacuum suction at the vacuum tube 204. As a result of the vacuum suction, the vacuum tube 204 engages the bill 150 at the bottom of the slot 114, thereby pulling the bill 150 to the vacuum tube 204 (FIG. 2B). The controller 202 then commands the vacuum drive mechanism 210 to retract the vacuum wheel 206 to a third position, which may be the same as the first position, (FIG. 2C). The controller 202 can then command the vacuum drive mechanism 210 to rotate the vacuum wheel 206 such that an end of the bill 150 is at a first set of wheels 216 of the wheeled guide 212 (FIG. 2D). The controller 202 can also command the wheeled guide drive mechanism 214 to begin turning the wheels 216 of the wheeled guide 212, such that the wheel is guided through the wheeled guide 212. At around the same time, the controller 202 can turn the vacuum source 208 off, thereby releasing the bill 150 from the vacuum tube 204. The bill 150 is guided through the wheeled guide 212 to the bill acceptor 130 (FIG. 2E). The bill acceptor 130 (discussed in further detail below) receives the bill 150 and outputs the bill 150 into the safe 140 (FIG. 2F).

The bill manipulator 200 may duplicate some or all of the components thereof described above for each slot 114. Additionally or alternatively, the vacuum drive mechanism 210 may be further configured to drive the vacuum tube 204 and the vacuum wheel 206 to a particular slot 114 and then to retract the vacuum tube 204 and the vacuum wheel 206 back towards the bill acceptor 130. It is noted that the explanation of the operation of the bill manipulator 200 of FIGS. 2A-F is provided for example only and variations of the bill manipulator 200 are contemplated. For instance, in the transition between FIG. 2B and 2C, the vacuum drive mechanism 210 may rotate the vacuum wheel 206 without retracting the vacuum wheel 206 to the third position.

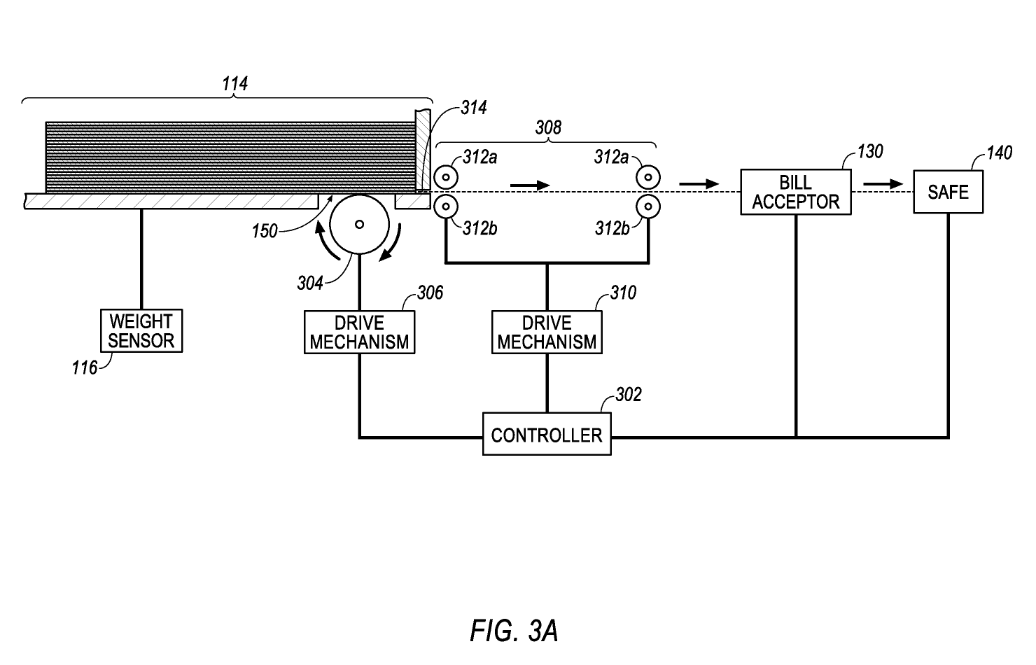

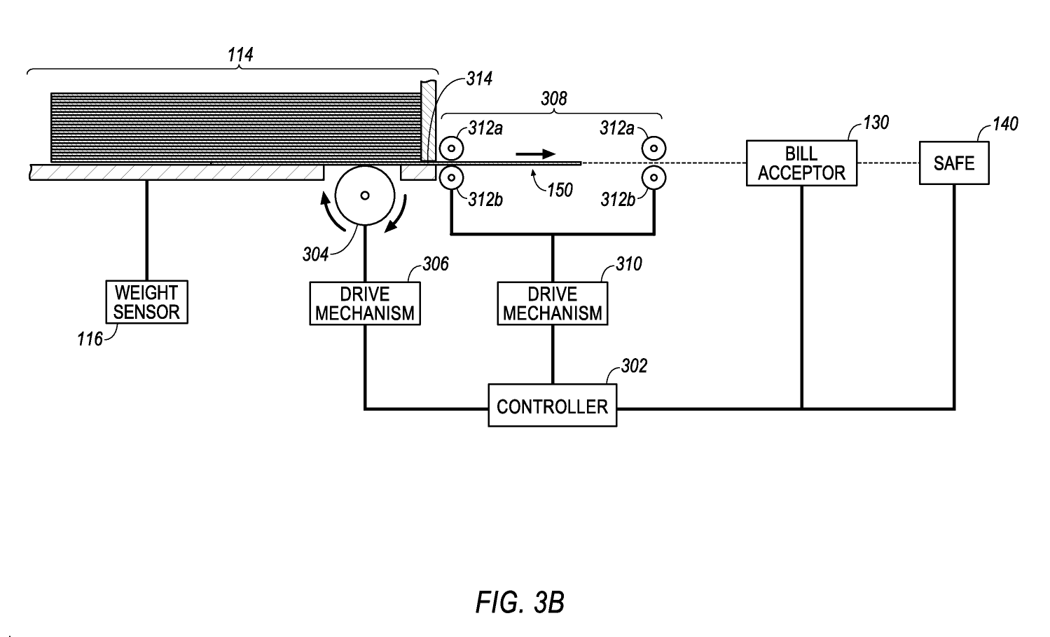

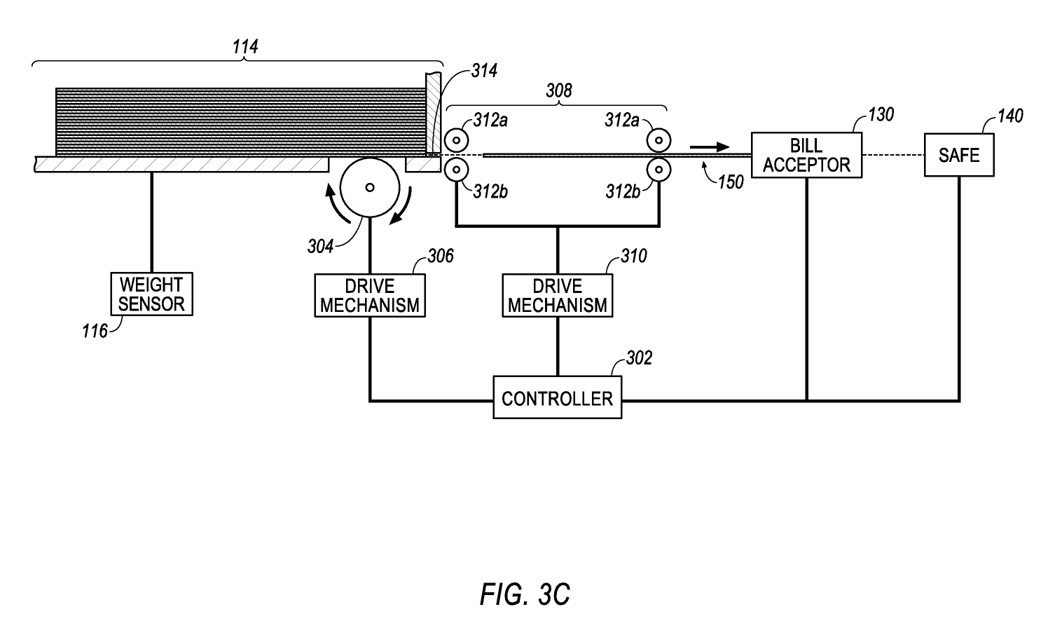

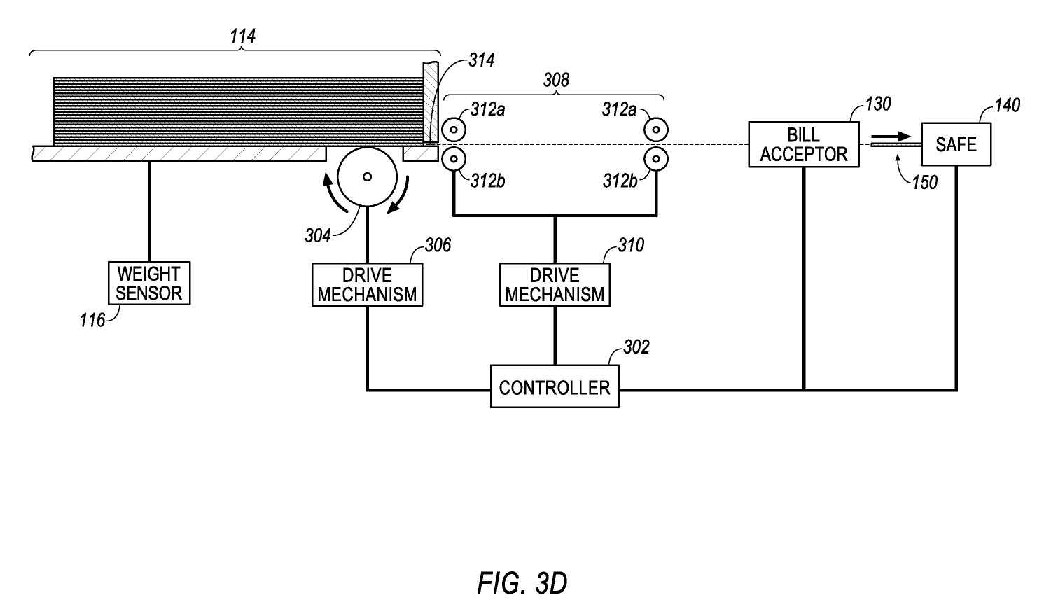

FIGS. 3A-3D illustrate a second example of a bill manipulator 300 according to some implementations of the present disclosure. In some implementations of the point-of-sale system 100, the first example bill manipulator 300 (or variations thereof) is the bill manipulator 120 of FIG. 1. In the illustrated example, the bill manipulator 300 includes a controller 302, a peeling wheel 304, a wheel drive mechanism 306, a wheeled guide 308, and a wheeled guide drive mechanism 310. The controller 302 can receive commands from the computing system 400 to remove a bill 150 from a defined slot 114 and/or commands to remove a defined number of bills from a defined slot 114. Upon removing a bill 150 or a defined number of bills 150 from the slot 114, the controller 302 can transmit an acknowledgment to the computing system 400.

In operation, the controller 302 commands the wheel drive mechanism 306 to rotate the peeling wheel 304 in a specific direction (e.g., clockwise). (FIG. 3A). The peeling wheel 304 can include a rough surface such that when the peeling wheel 304 is turned, it catches the bottom bill 150 and peels the bottom bill 150 away from rest of the bills 150. In this way the bill 150 is slid through a slit 314 in the slot 114 and to the first set of wheels 312 of the wheeled guide 308 (FIG. 3B). The controller 302 commands the wheeled guide drive mechanism 310 to turn the wheels 312 of the wheeled guide 308, such that the bill 150 is guided through the wheeled guide 308 and to the bill acceptor 130 (FIG. 3C). The bill acceptor 130 (discussed in further detail below) receives the bill 150 and outputs the bill 150 into the safe 140 (FIG. 3D).

The bill manipulator 300 of FIGS. 3A-3D is provided for example only. The bill manipulator 300 of FIGS. 3A-3D can include additional components. For instance, the slit 314 may include a separator mechanism (e.g., one or more additional wheels or compliant rollers) to ensure that only a single bill passes through the slit 314 at a time. In such a configuration, the additional wheels or compliant rollers rotate to pull the bill through the slit 314 and to the wheeled guide 308. The separator mechanism may be controlled by another drive mechanism, also not shown. It is envisioned that any other suitable bill manipulator 120 may be implemented in the point-of-sale system 100.

Referring back to FIG. 1, the bill acceptor 130 receives bills 150 from the bill manipulator 120. The bill acceptor 130 is configured to verify the authenticity of the bill 150 and to determine the denomination of the bill 150. The bill acceptor 130 can be any suitable bill acceptor 130, such as the bills acceptors 130 produced and sold by MEI of Malvern, Pa. It is noted that the bill acceptor 130 can be any suitable device that authenticates and/or determines a denomination of the bill 150. The bill acceptor 130 outputs the bill 150 into the safe 140 or any other suitable currency storage unit. The bill acceptor 130 may be directly or indirectly coupled to the safe 140.

The safe 140 (or any other suitable currency storage unit) stores currency deposited therein. The operator of the point-of-sale system 100 (e.g., the manager or business owner) may restrict access to the safe 140, such that the safe 140 is a secured location. In this way, the point-of-sale system 100 is configured to transfer bills 150 from an unsecure location (i.e., the till 112) to a secure location (i.e., the safe 140).

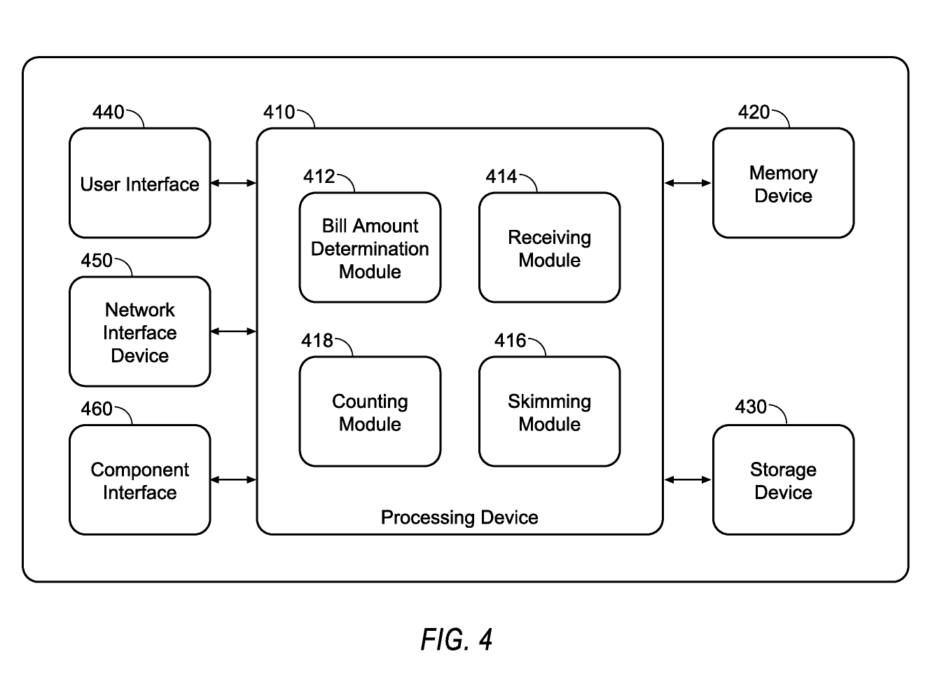

The computing system 400 is configured to control operation of the point-of-sale system 100 and to provide an interface between the user and the point-of-sale system 100. FIG. 4 illustrates an example configuration of the computing system 400. In the illustrated implementation, the computing system 400 can include a processing device 410, one or more memory devices 420 (e.g., RAM and/or ROM), one or more storage devices 430 (e.g., hard disk drive), one or more user interfaces 440 (e.g., electronic display device, keyboard, touchscreen, and/or mouse) one or more network interface devices 450 (e.g., a LAN port, antenna, and/or a wireless card), and one or more component interfaces 460.

The component interface 460 can provide interface between the processing device 410 and the components of the point-of-sale system 100. For example, the component interface 460 may provide an interface to the bill manipulator 120, the weight sensors 116, the bill acceptor 130, and/or the safe 140. The component interface 460 can include a bus (e.g., PCI bus or SCSI bus) that connects the output of a component (e.g., bill manipulator 120 or weight sensor 116) to the processing device 410.

The processing device 410 can include one or more physical processors that execute machine readable instructions. In implementations having two or more processors, the processors can execute in a distributed or individual manner. The processing device 410 can execute a bill amount determination module 412, a receiving module 414, a skimming module 416, and a counting module 418, all of which can be implemented as machine readable instructions. The machine readable instructions may be initially stored in the storage device 430 and/or the memory device 420.

The bill amount determination module 412 determines and outputs the number of bills 150 in a particular slot 114 of the till 112. In some implementations, the bill amount determination module 412 receives the weight measurement of a slot 114 from a corresponding weight sensor 116. In some implementations, the bill amount determination module 412 can subtract any constants from the weight measurement (e.g., the weight of the slot 114 itself) to obtain the collective weight of the bills 150. In other implementations, the weight sensors 116 may be calibrated to output a weight measurement that is compensated for the weight of the actual slot 114. In these implementations, the outputted weight measurement is the collective weight of the bills 150. The bill amount determination module 412 divides the collective weight of the bills 150 by the known weight of one bill 150 (e.g., one gram or 1.2 grams). Thus, if the collective weight of the bills 150 is 10 grams and the weight of a single bill 150 is one gram, then the bill amount determination module 412 determines that the slot 140 has ten bills 150 in it.

In some implementations, the bill amount determination module 412 can be further configured to determine and output the value of the bills 150 in the slot 114. In these implementations, the bill amount determination module 412 can receive the denomination of the bills 150 stored in the slot 114 and can multiply the value of the denomination by the number of bills 150 in the slot 114. For example, if the bill amount determination module 412 determines that there are ten bills 150 in the slot 114 and the slot 114 stores five-dollar bills, the bill amount determination module 412 can output fifty dollars in addition or instead of outputting that there are ten bills 150 in the slot 114.

The receiving module 414 maintains the inflow and outflow of cash in the till 112. Each time a cash transaction is made, the receiving module 414 updates an expected till value 112. The expected till value 112 is the amount of money expected to be in the till 112 at a given time. For instance, if the till 112 originally contained $100.00 and the subsequent transaction was a purchase for $11.11, the receiving module 414 updates the expected till value to $111.11. Similarly, if a refund is issued to a customer, the receiving module 414 can update the expected till value 112 accordingly. For instance, if a cash refund is subsequently issued for $13.21 when there is $111.11 in the till 112, the receiving module 414 can reduce the expected till value to $97.90.

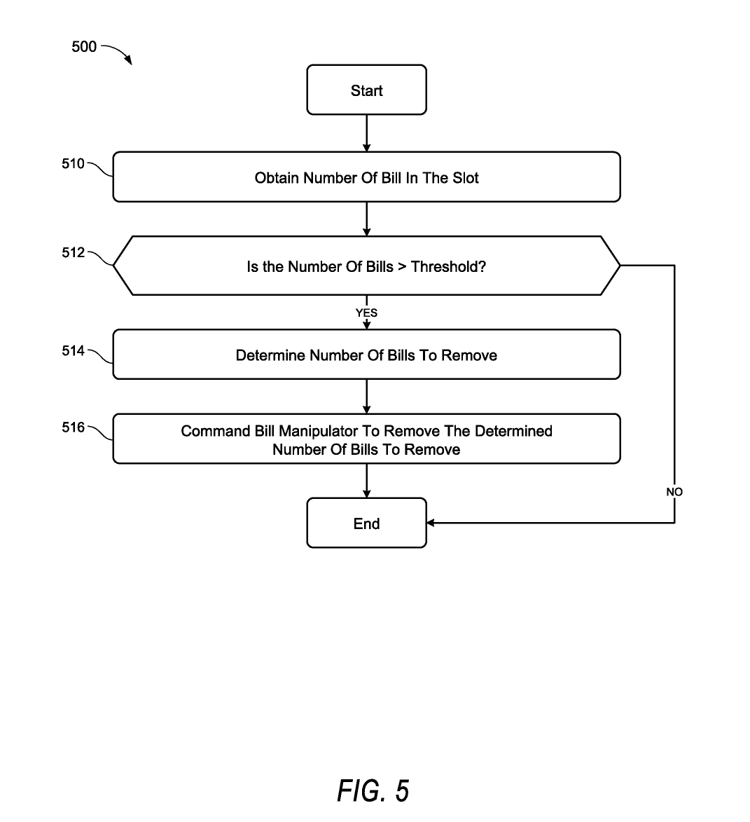

The skimming module 416 determines a number of bills 150 to be removed from the till 414 and commands the bill manipulator 120 to transfer the bills 150 from the till 112 to the bill acceptor 130 (which ultimately directs the bills 150 to the safe 140). FIG. 5 illustrates an example set of operations for a method 500 for skimming a slot 114 of a till 112. The skimming module 416 can execute the method 500 for each of the slots 114 of the till 112. The method 500 may be executed at specific times (e.g., every hour) or when the expected till value exceeds a threshold (e.g., expected till value >$300.00).

At operation 510, the skimming module 416 can obtain the number of bills 150 in the slot 114. The skimming module 416 can obtain the number of bills 150 from the bill amount determination module 412. Additionally or alternatively, the skimming module 416 can obtain the value of the bills 150 in the slot 114.

At operation 512, the skimming module 416 can determine whether the number of bills 150 in the slot 114 exceeds a threshold. For example, the manager or maintainer of the point-of-sale system 100 may choose to limit the number of twenty dollar bills 150 to no more than eight bills 150 (i.e., $160.00) at any given time. Thus, in this case, the threshold is set to eight. If the number of bills 150 in the slot does not exceed the threshold, then the skimming module 416 does not skim any bills 150 from the slot 114.

When the number of bills 150 in the slot exceeds the threshold, the skimming module 416 determines a number of bills 150 to remove from the slot 114, as shown at operation 514. The skimming module 416 may be configured to reduce the number of bills 150 in the slot 114 to a particular reset number of bills 150. For example, the owner or maintainer of the point-of-sale system 100 may set the reset number of twenty dollar bills to five, such that the skimming module 416 reduces the number of twenty dollar bills in the slot to five twenties. The skimming module 416 can subtract the reset number from the number of the bills 150 in the slot 114 to obtain the number of bills 150 to remove from the slot 114.

At operation 516, the skimming module 416 can command the bill manipulator 120 to transfer the number of bills 150 to be removed from the slot 114 to the safe 140. The skimming module 416 can send a command (or multiple commands) to the bill manipulator 120. In response to the commands, the bill manipulator 120 removes the requested number of bills 150 from the slot 114. In some implementations, the skimming module 416 receives acknowledgements from the bill manipulator 120 each time a bill 150 is successfully transferred to the safe 140. The skimming module 416 can use these acknowledgments to maintain a running total of bills 150 that have been transferred to the safe 140 from the till 112 and the denominations of those bills 150.

The method 500 of FIG. 5 is provided for example. Variations of the method 500 are contemplated and are within the scope of the disclosure.

Referring back to FIG. 4, the counting module 418 determines the actual value of the bills 150 in the till 112. The counting module 418 can be executed when the till 112 is to be emptied (e.g., at closing time).

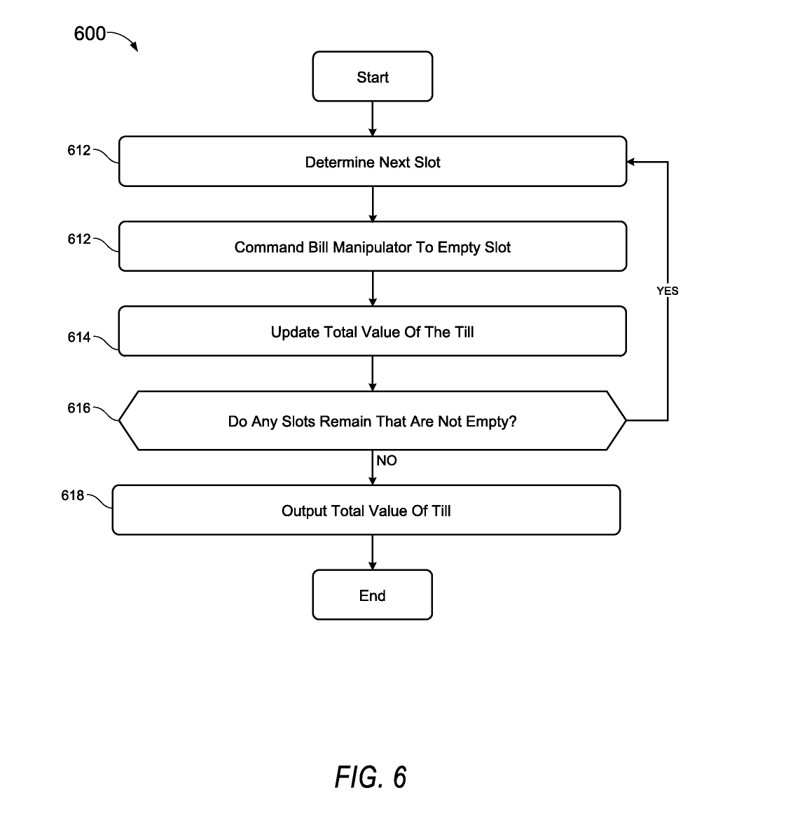

FIG. 6 illustrates an example set of operations for a method 600 for counting the bills 150 in the till 112.

At operation 610, the counting module 418 determines a next slot 114 of the till to empty 112. At the first iteration, the next slot 114 is the first slot 114 (e.g., the rightmost slot or leftmost slot). At subsequent iterations, the next slot 114 can be the slot 114 abutting the previous slot 114 (or any other unemptied slot 114).

At operation 612, the counting module 418 instructs the bill manipulator to empty the slot 114. In some implementations, the counting module 418 can obtain the number of bills 150 in the slot 114 from the bill amount determination module 412. The counting module 418 can command the bill manipulator 120 to remove the number of bills 150 from the slot 114. In other implementations, the counting module 418 can continue to command the bill manipulator 120 to remove bills 150 from the slot 140 until the bill amount determination module 412 determines that the slot 140 is empty. The counting module 418 can monitor the acknowledgments received from the bill manipulator 120 to determine the total number of bills 150 in the slot 114 and, when an acknowledgment is not received in response to a command (or multiple consecutive commands), to determine that the slot 114 is empty.

At operation 614, the counting module 418 updates the till total value. The till total value can be a running total of the till 114. Each time a bill 150 is passed through the bill acceptor 130, the bill acceptor 130 can verify that the bill 150 is authentic and can output the denomination of the bill 150 (this may help identify bills 150 that were accidently placed in the wrong slot). The counting module 418 can receive the denomination of the bill 150 and can update a total value of the slot 114. Once the slot 114 is empty, the counting module 418 can add the total value of the slot 114 to the total value of the till 112. Alternatively, each time a bill 150 is verified by the bill acceptor 130, the counting module 418 can add the value of the verified bill 150 to the total value of the till 112.

At operation 616, the counting module 418 determines whether there are additional slots to empty. If so, the counting module 418 determines the next slot 114, as shown at operation 610. If there are no slots 114 left to empty, the counting module 419 outputs the till total value, as shown at operation 618. Outputting the till total value can include storing the till total value in the memory device 420 and/or the storage device 430, transmitting the till total value to a remote computer via the network interface device 450, and/or outputting the till total value via the user interface 440 (e.g., on an electronic display device).

The method 600 of FIG. 6 is provided for example only. Variations of the method 600 are contemplated and are within the scope of the disclosure.

As can be appreciated from the foregoing disclosure, the disclosed point-of-sale system 100 allows cash to be transferred from a relatively unsecure location to a secure location, without requiring an employee to handle the cash.

Various implementations of the systems and techniques described here can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Implementations of the subject matter and the functional operations described in this specification can be implemented in digital electronic circuitry, or in computer software, firmware, or hardware, including the structures disclosed in this specification and their structural equivalents, or in combinations of one or more of them. Moreover, subject matter described in this specification can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The terms “data processing apparatus”, “computing device” and “computing processor” encompass all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as an application, program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

One or more aspects of the disclosure can be implemented in a computing system that includes a backend component, e.g., as a data server, or that includes a middleware component, e.g., an application server, or that includes a frontend component, e.g., a client computer having a graphical user interface or a Web browser through which a user can interact with an implementation of the subject matter described in this specification, or any combination of one or more such backend, middleware, or frontend components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data to a client device (e.g., for purposes of displaying data to and receiving user input from a user interacting with the client device). Data generated at the client device (e.g., a result of the user interaction) can be received from the client device at the server.

While this specification contains many specifics, these should not be construed as limitations on the scope of the disclosure or of what may be claimed, but rather as descriptions of features specific to particular implementations of the disclosure. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multi-tasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

A number of implementations have been described. Nevertheless, it will be understood that various modifications may be made without departing from the spirit and scope of the disclosure. Accordingly, other implementations are within the scope of the following claims. For example, the actions recited in the claims can be performed in a different order and still achieve desirable results.

What is claimed is:

1. A point-of-sale terminal system, comprising:
a till having a plurality of slots, each slot being configured to hold currency in the form of bills;
a bill manipulator coupled the plurality of slots;
a bill acceptor coupled to the bill manipulator, wherein the bill manipulator moves individual bills from the till to the bill acceptor and the bill acceptor outputs bills to a currency storage unit;
a processing device configured to:
determine a number of bills in each of the plurality of slots;
determine a number N indicating a number of bills to remove from at least one slot in the plurality of slots based on the number of bills in the at least one slot; and
command the bill manipulator to transfer N bills from the at least one slot.

2. The point-of-sale terminal of claim 1, wherein the currency storage unit is a safe that receives the bills from the bill acceptor.

3. The point-of-sale terminal of claim 1, wherein the processing device is further configured to:
facilitate a transaction;
determine an amount of currency received during the transaction; and
update an expected cash value of the till based on the amount of currency received during the transaction.

4. The point-of-sale terminal of claim 1, further comprising a plurality of weight sensors, each weight sensor coupled to a respective slot of the plurality of slots and configured to output a weight of the respective slot.

5. The point-of-sale terminal of claim 4, wherein the processing device determines the number of bills in each of the plurality of slots based on the weight of the slot.

6. The point-of-sale terminal of claim 1, wherein the processing device is further configured to:
command the bill manipulator to empty the bills in each of the plurality of tills into the bill acceptor;
receive a value of each bill passed through the bill acceptor; and
determine a final amount of currency in the till based on the respective values of the bills passed through the bill acceptor.

7. The point-of-sale system of claim 1, wherein the bill acceptor is configured to verify the authenticity of a received bill and the value of the received bill.

8. A point-of-sale system, comprising:
a till having a slot;
a bill manipulator;
a bill acceptor coupled to the bill manipulator, wherein the bill manipulator moves individual bills from the slot to the bill acceptor and the bill acceptor outputs bills to a currency storage unit;
a processor configured to:
determine a number of bills in the slot;
determine a number N indicating a number of bills to remove from the slot based on the number of bills in the slot; and
command the bill manipulator to transfer N bills from the slot to the currency storage unit.

9. The point-of-sale system of claim 8, wherein the currency storage unit is a safe that receives the bills from the bill acceptor.

10. The point-of-sale terminal of claim 8, wherein the processing device is further configured to:
facilitate a transaction;
determine an amount of currency received during the transaction; and
update an expected cash value of the till based on the amount of currency received during the transaction.

11. The point-of-sale terminal of claim 8, further comprising a weight sensor coupled to the slot that outputs a weight of the slot.

12. The point-of-sale terminal of claim 11, wherein the processing device determines the number of bills in the slot based on the weight of the slot.

13. The point-of-sale terminal of claim 8, wherein the processing device is further configured to:
command the bill manipulator to transfer all of the bills in the slot into the bill acceptor;
receive a value of each bill passed through the bill acceptor; and
determine a final amount of currency in the till based on the respective values of the bills passed through the bill acceptor.

14. The point-of-sale system of claim 8, wherein the bill acceptor is configured to verify the authenticity of a received bill and the value of the received bill.

15. A method of operating a point-of-sale system, the method comprising:
determining, at a processing device, a number of bills in a slot of a till;
determining, at the processing device, whether the number of bills exceeds a threshold;
when the number of bills exceeds the threshold:
determining, at the processing device, a number N indicating a number of bills to remove from the slot based on the number of bills in the slot; and
commanding, from the processing device, a bill manipulator to transfer N bills from the slot to a secure location.

16. The method of claim 15, wherein the secure location is a safe.

17. The method of claim 15, wherein determining the number of bills in the slot includes:
receiving, at the processing device, a weight signal indicating the weight of the slot; and
determining, at the processing device, a weight of the bills in the slot based on the weight signal; and
determining, at the processing device, the number of bills in the slot based on the weight of the bills.

18. The method of claim 15, wherein determining whether the number of bills in the slot exceeds a threshold is performed upon determining that an expected value of bills in the till exceeds a value threshold.

19. The method of claim 15, wherein the number N is based on a difference between the number of bills in the slot and a reset number of bills, the reset number of bills indicating a number of bills to have in the slot after the bills are transferred to the secure location.

20. The method of claim 15, further comprising transferring, by the bill manipulator, the N bills from the slot to the secure location, wherein the bill manipulator feeds the bills into a bill acceptor and the bill acceptor outputs the bills into the secure location.
